(19) United States
(12) Patent Application Publication
(10) Pub. No.: US 2007/0057490 A1
(43) Pub. Date: Mar. 15, 2007

(54) EXTERNAL AIR BAG FOR A VEHICLE

(76) Inventor: Cassius Deflorimonte, Oshawa, ON (CA)

Correspondence Address: DIMOCK STRATTON LLP, 20 QUEEN STREET WEST SUITE 3202, BOX 102, TORONTO, ON, M5H 3R3, CA

(21) Appl. No.: 11/531,997

(22) Filed: Sep. 14, 2006

Related U.S. Application Data
(60) Provisional application No. 60/716,529, filed on Sep. 14, 2005.

(51) Int. Cl. B60R 21/16; B60K 28/10; B60R 19/20

(52) U.S. Cl. 280/730.1; 293/107; 180/274

(57) ABSTRACT

An airbag apparatus for mounting on an external surface of a vehicle, comprising an airbag, a propellant for inflating the air bag, a trigger and a housing removably mounted to the external surface of the vehicle, whereby the propellant is released to inflate the airbag by the trigger.

### FIELD OF THE INVENTION

This invention relates generally to the field of automotive safety systems. More particularly, this invention relates to an inflatable air bag system and apparatus that is externally mounted on an automobile and deployed for the purpose of reducing vehicle damage resulting from low speed collisions.

### BACKGROUND OF THE INVENTION

The potential for being involved in an automobile collision is a risk that is assumed by anyone who drives.

Under adverse weather conditions, even when driving at reduced speeds, that risk is even higher and collisions often occur. Such low speed collisions can result in damage to the vehicle and injury to the occupants. As a result, it would be advantageous if the impact of such low speed collisions could be reduced, thereby reducing the likelihood that damage to the vehicle and injury to the occupants that would otherwise result.

Current safety measures that have been implemented in vehicles to reduce the consequences of automobile collisions involve strategies directed specifically at the occupants. These measures have included seatbelts, interior front air bags on the driver and passenger sides as well as interior side air bags, structural reinforcements to the body of the vehicle and crumple zones. Each of these strategies is designed to prevent the occupants of the vehicle cabin from impacting with the hard surfaces on the vehicles interior by either immobilizing the occupant, creating a barrier between the occupant and the interior of the vehicle, or maintaining the physical integrity of the passenger compartment by using structural elements of the vehicle to absorb the impact. Furthermore, most of these designs are intended to protect the occupants of the vehicle in the event of a high speed, high impact collision, and protective devices such as interior air bags often are designed not to deploy in a low impact collision.

There currently is a need for devices that are intended to decrease the potential for both vehicle damage and injury to the occupants in the event of a low speed, low impact collision that would, nonetheless, result in damage to the vehicle and possibly injury to the vehicle's occupants. Such collisions are very common in circumstance where, due to inclement weather, roads are either wet or icy and the driver, although travelling at a low speed, is simply unable to bring the vehicle to a stop in order to avoid a collision. Therefore, there is a need for a device that will lessen the effect of the impact of such collisions such that the amount of damage to the one or more vehicles involved in the collision is reduced or damage is prevented, and the potential for injury to the occupants of any of the vehicles involved is also reduced. Furthermore, it would be advantageous for such a device to be cost effective and reusable.

### SUMMARY OF THE INVENTION

The present invention provides an apparatus for increasing vehicle safety and reducing the chance of damage occurring to vehicles in low speed collisions. The apparatus comprises an air bag for mounting on an external surface of a vehicle and for deployment in advance of a low speed collision. The apparatus further comprises a propellant for inflating the air bag, a trigger and a housing. The airbag and propellant are mounted within the housing, which in turn is preferably removably mounted to an external surface of the vehicle. The propellant is released to inflate the airbag by the trigger, which is preferably (but not necessarily) manually actuated.

In a further embodiment of the invention the airbag comprises a plurality of chambers, at least one chamber being adapted to secure the airbag within the housing by a retaining means and at least one other chamber being adapted to allow the airbag to be inflated by the propellant.

In the preferred embodiment the retaining means for the air bag comprises a slotted bracket whereby the slot is closed at the first end and open at the second end of the bracket, the second end being provided with a means for releasably closing the bracket, which may comprise a hinged clasp.

According to one aspect of the invention, the trigger comprises at least one depressible switch located within the vehicle passenger compartment.

In a further embodiment of the invention a wedge-shaped adaptor means divided into a first portion and a second portion with the first portion having a first surface and the second portion having a second surface, whereby the first surface is mounted onto an external surface of a vehicle and the airbag apparatus is mounted to the second surface. The first and second portions of the adaptor may be joined at the narrow end of the wedge by a flexible joint and at the inclined end of the wedge by a means for adjusting the spacing between the first and second portions, thereby controlling the angle of the wedge and the direction at which the airbag is deployed. The adapter means may alternatively be an integral component of the housing.

In a further embodiment of the present invention, the wedge-shaped adaptor means and the housing combine to form a retaining means for the airbag. In this embodiment, the back surface of the housing incorporates a slotted opening. In addition, both the back of the housing and the first portion of the wedge-shaped adaptor have protruding surfaces that are complementary in shape such that the two surfaces interconnect when the housing is mounted onto the wedge-shaped adaptor. The air-bag is secured to the housing by feeding a portion of the air bag through the slotted opening and around one of the two protruding surfaces and back through the slotted opening. In this way, when the housing is mounted onto the wedge-shaped adaptor and the protruding surfaces interconnect, the bag is securely clamped in place. The air bag may further be provided with a means for attaching the free extremity to the rest of the air bag after being fed back through the slotted opening. Examples of such means for attaching the free end of the air bag could be one or more clasps or one or a number of pieces of Velcro.

The apparatus of the invention may be mounted to a front or rear vehicle bumper, preferably the location provided for affixing a license plate.

The present invention thus provides:

1. An airbag apparatus for mounting on an external surface of a vehicle and for deployment in advance of a low speed collision, comprising
a housing,
an airbag mounted in the housing,
a propellant for inflating the air bag, and
a trigger for releasing the propellant,
whereby the airbag and propellant are mounted within said housing and said housing is removably mounted to an external surface of a vehicle and whereby said propellant is triggered to inflate said airbag by said triggering means.

2. The airbag apparatus of paragraph 1 in which the propellant is contained within the housing.

3. The airbag apparatus of paragraph 1 in which the airbag comprises a plurality of chambers, at least one chamber being adapted to secure the airbag within the housing by a retaining means and at least one chamber being adapted to allow the airbag to be inflated by the propellant.

4. The airbag apparatus of paragraph 3 in which the retaining means comprises an elongate slotted bracket whereby the slot is closed at the first end and open at the second end provided with a means for releasably closing the second end.

5. The airbag apparatus of paragraph 4 in which the means for releasably closing the second end comprises a hinged clasp.

6. The airbag apparatus of paragraph 1 in which the trigger comprises at least one depressible switch located within the vehicle passenger compartment.

7. The airbag apparatus of paragraph 1 in which the housing is mounted on an adaptor comprising a wedge divided into a first portion and a second portion, the first portion having a first surface and the second portion having a second surface, whereby the ramp is mounted to the vehicle at the first surface and the airbag apparatus is mounted to the ramp at the second surface

8. The airbag apparatus of paragraph 7 in which the first portion and second portion are joined at a narrow end of the ramp by a flexible joint and a spacing between the first and second portions at a wider end is adjustable to thereby control the angle of the ramp and the direction at which the airbag is deployed.

9. The airbag apparatus of paragraph 7 in which said adapter means is an integral component of the housing.

10. The airbag apparatus of paragraph 1 in which said external vehicle surface is a front or rear vehicle bumper.

11. The airbag apparatus from paragraph 10 in which the external vehicle surface comprises the vehicle's means for affixing a license plate.

12. An airbag for an airbag apparatus, comprising a plurality of chambers, each chamber comprising a means for permitting inflation by a propellant and a valve for permitting controlled deflation at a predetermined air bag chamber internal air pressure.

### BRIEF DESCRIPTION OF THE DRAWINGS

In drawings which illustrate by way of example only a preferred embodiment of the invention,

FIG. 1a is a perspective view of the housing with the housing cover in the open position and the airbag in a stowed condition.

FIG. 1b is a perspective view of the housing with the cover in the closed position.

FIG. 1c is a perspective view of the housing with the housing cover in the open position and the airbag in a deployed condition.

FIG. 2 is a perspective view of the ramp adapter.

FIG. 3 is a schematic view showing an additional embodiment of the airbag of the invention.

FIG. 4a is a schematic view showing an additional embodiment of the airbag of the invention.

FIG. 4b is a perspective view of the airbag shown in FIG. 4a.

FIG. 5a is front view of the adapter and rear view of the housing according to the alternative embodiment of the retaining means for the air bag.

FIG. 5b is a cross-section of the adapter and the housing of the alternate embodiment of the retaining means for the air bag.

### DETAILED DESCRIPTION OF THE INVENTION

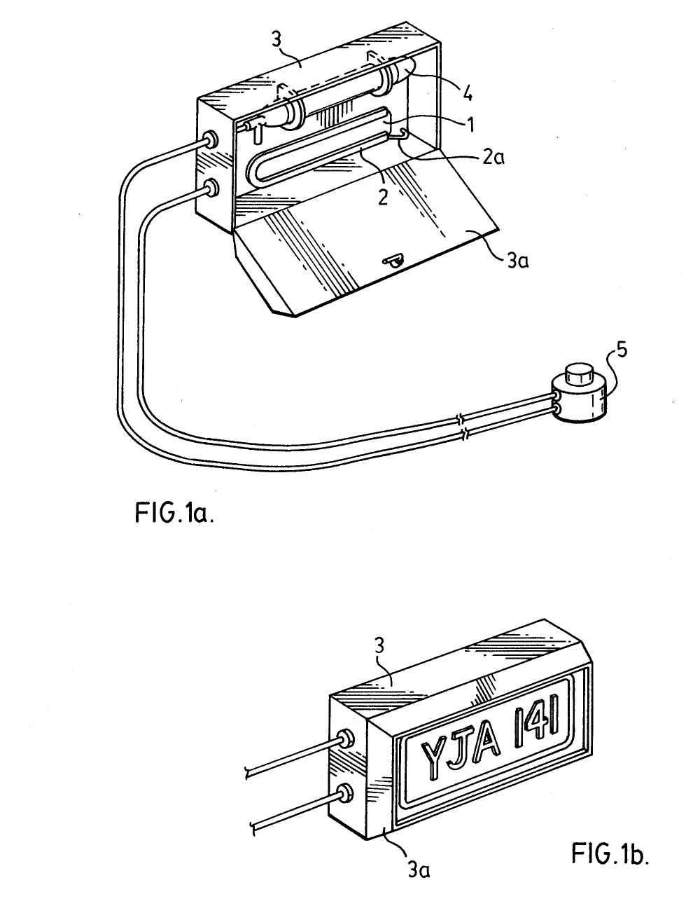

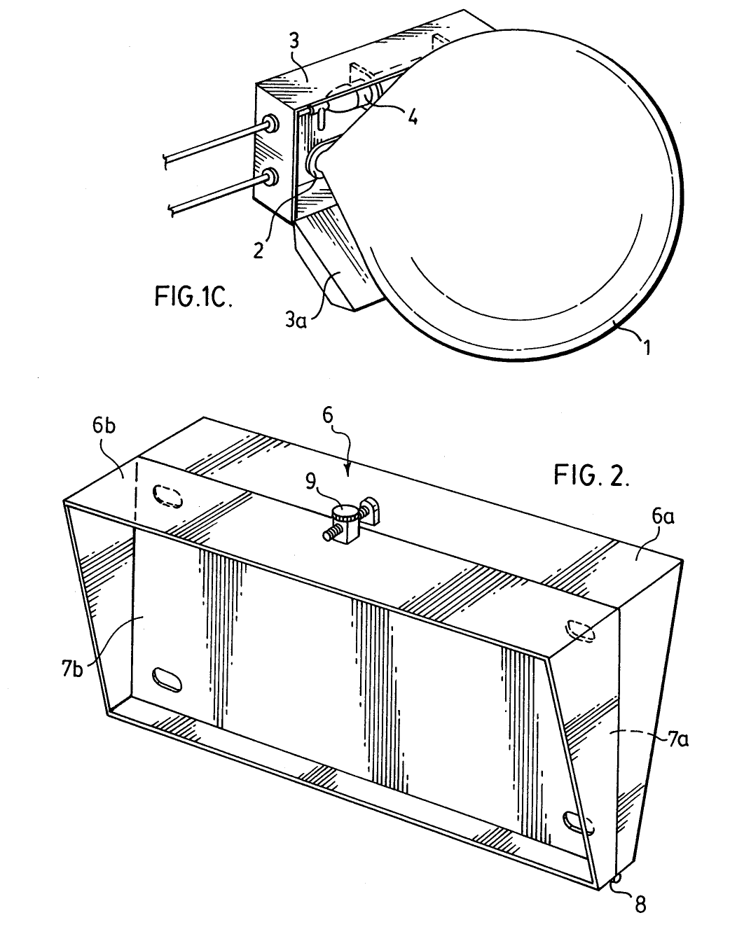

The preferred embodiments of the present invention are best described with reference to the accompanying drawings. Referring to FIG. 1a, which shows the airbag apparatus in a pre-deployment or stowed configuration, the apparatus comprises an airbag 1 secured by the retaining means 2, which is shown with a hinged clasp 2a in the open position. In the preferred embodiment, the airbag 1 is adapted to slide into the slot formed by the retaining means 2 in order to be secured when the clasp 2a is in the closed position, within the housing 3 both before and after it is deployed. The propellant 4 is also secured within the housing 3, for example by braces 4a bolted to the housing 3, and is configured to permit inflation of the airbag 1 upon being activated by the trigger 5 which, in the embodiment shown in FIG. 1a, is actuated by the driver by a depressible button located within the vehicle cabin, positioned within reach of the driver.

Referring to FIG. 1b, prior to deployment of the airbag apparatus, the housing 3 is releasably sealed by a housing door 3a that is maintained in the closed position by conventional means including but not limited to a latch or clasp.

Upon activation by the driver of the trigger 5 by engaging the depressible button, the propellant 4 causes the airbag 1 to be inflated. The force exerted by inflation of the airbag 1 causes the housing door 3a to open to allow the airbag 1 to be fully inflated. Referring to FIG. 1c, the airbag 1 is in a fully deployed condition when the airbag 1 has been fully inflated 1a by the propellant 4, has opened the housing door 3a to permit expansion beyond the housing 3, and remains held to the housing by the retaining means 2.

In the preferred embodiment, the housing 3 is affixed to an outside surface of a vehicle, preferably the front or rear bumper. More preferably, the housing 3 is affixed to the location to which the license plate or license plate holder is affixed, and the housing cover 3a is provided with the means to affix the license plate.

The shape of the housing may be altered to a shape that is more aesthetically pleasing and, therefore, amenable to a particular vehicle design. It is understood that there is a wide range of vehicle designs and that the shape of the housing and specific manner in which it is affixed to the vehicle will vary.

The propellant 4 comprises any substance that can be used to effect a rapid inflation of the airbag 1. In one embodiment, inflation is achieved using a solid propellant inflation system that comprises a gas generator and an ignition system. Solid propellant inflation systems for internal vehicle air bag systems that include a sensor and a means for igniting the propellant are well know and are similarly useful for the present invention. The most commonly used propellant for a solid propellant inflation system uses sodium azide as a gas generator. In an additional embodiment, the propellant is compressed gas contained in a suitable canister fitted with a release valve. Other suitable propellants appropriate for use with the present invention would be appreciated by a person skilled in the art.

In its preferred embodiment, the air bag apparatus is activated manually by the driver. By analogy to the well known internal air bag system, manual activation is achieved by replacing the sensor with a trigger or switch. The driver is able to activate the air bag apparatus by manually actuating the trigger 5 which is placed within the vehicle's passenger compartment. The present invention includes embodiments using any suitable switch that allows the driver to actuate the air bag apparatus from within the passenger compartment. Examples include a switch located within the passenger compartment that, when triggered, sends an electrical impulses through a wires or wires between the switch and the inflation system that either causes the ignition of the solid propellant if a solid propellant inflation system is employed or causes the valve on the canister of compressed gas to open. The details of the means by which the triggering means effects the ignition of the solid propellant or release of the compressed gas are known to those skilled in the art. The present invention also contemplates embodiments in which manual inflation is triggered wirelessly as well as embodiments in which inflation is triggered automatically using sensors.

Optionally, the invention incorporates a means for adjusting the angle with respect to the vehicle surface on which the airbag is mounted, in order to optimize the effectiveness of the invention on different vehicles. Referring to FIG. 2, the means for adjusting the angle of deployment comprises an adjustable wedge-shaped adaptor 6 that is divided into a first portion 6a having a first surface 7a and a second portion 6b having a second surface 7b. The two portions of the adaptor 6 are preferably joined at the narrow end 8 by a flexible joint. In one embodiment, the flexible joint is a hinge; however, any manner of creating a flexible joint is acceptable provided it has the strength to withstand normal driving conditions and deployment of the airbag 1. The first portion 6a and second portion 6b are joined at the wide end 9 of the adaptor by a means for adjusting the angle of the adaptor, by increasing the space between the first portion 6a and second portion 6b of the adaptor at the wider end. The means for adjusting the angle of the adaptor can be one or more adjusting screws or other similar mechanisms. The first surface 7a is provided with mounting means for affixing the ramp to the outside surface of a vehicle. The ramp is preferably mounted onto the front or rear bumper of a vehicle and, more preferably, onto the means provided on a bumper for affixing a license plate. The means provided on the first surface 7a for affixing the ramp onto a bumper may consist of openings spaced according to the spacing of openings provided on a vehicle bumper for affixing a license plate or license plate holder. The second surface 7b is similarly provided with a means for securing the airbag apparatus to the ramp 6 which, in the embodiment shown in FIG. 2, consists of a set of openings that would allow the airbag apparatus to be secured onto the ramp using conventional means such as screws or bolts.

In operation, the adaptor 6 is installed in place of the vehicle's license plate holder and adjusted to the desired angle by separating the first portion 6a and second portion 6b at the wider end of the adaptor 6. The airbag housing 3 is then affixed to the adaptor 6 such that the angle at which the airbag is deployed will be determined by the angle between first portion 6a and second portion 6b. It is not essential that the adaptor 6 be separate from the mounting means, and in an alternate embodiment of the invention the adaptor is an integral part of the mounting means (not shown).

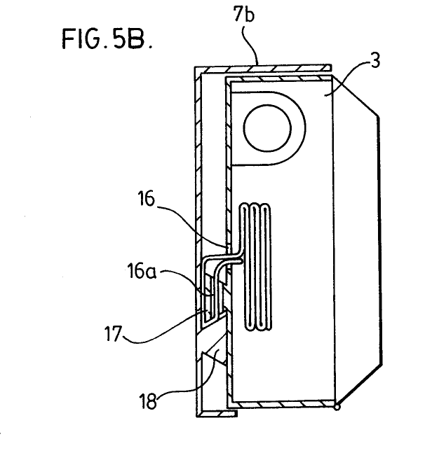

The adaptor 6 and housing 3 may combine to form an alternate retaining means for the airbag 1. Referring to FIGS. 5a and 5b, in this embodiment, the back surface of housing 3 incorporates a slotted opening 16. In addition, both the back of housing 3 and the second surface 7b of the second portion 6b of the wedge-shaped adaptor include a first 17 and second 18 protruding surfaces, respectively, that are complementary in shape such that the two protruding surfaces interconnect when the housing is mounted onto the adaptor 6. The air-bag 1 is secured to the housing by feeding one extremity through the slotted opening and around protruding surface 17, through a second slotted opening 16b formed between the housing 3 and protruding surface 17 and back into housing 3 through slotted opening 16. Upon mounting the housing 3 onto the wedge-shaped adaptor 6, the protruding surfaces interconnect and securely clamp the air bag in place. The air bag may be further secured by attaching the free extremity to the rest of the air bag after being fed back through the slotted opening. The may be accomplished by any number of well know means for attaching two surfaces together such as, for example, one or more clasps or one or more pieces of Velcro.

For simplicity and effectiveness, the preferred embodiment of the present invention has the mounting means conveniently mounted in place of the front or rear license plate, which ensures that the airbag apparatus is centered on the front or rear of the vehicle. However, it is within the scope of the present invention to include any number of airbag apparatuses that can be distributed along the front or rear vehicle bumper of a vehicle. The number and exact position of each airbag apparatus will to some extent depend on the design of the vehicle.

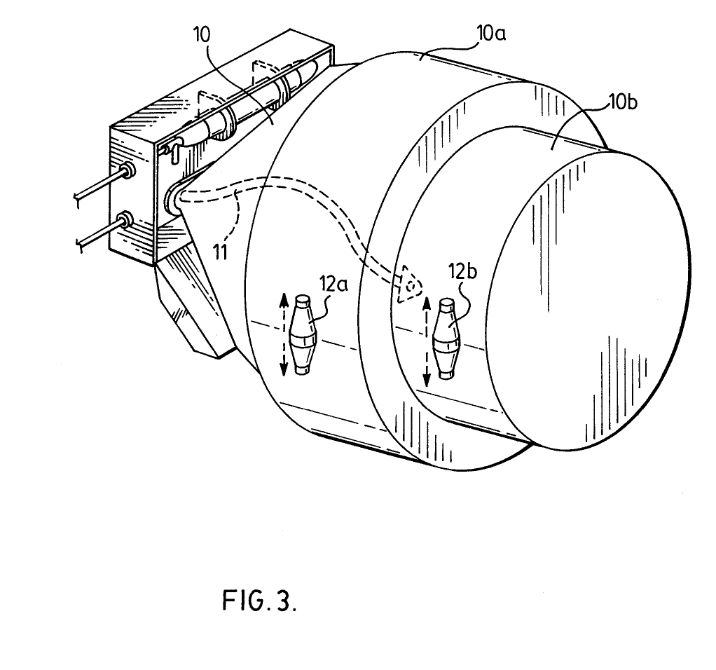

In its simplest embodiment, the airbag 1 of the airbag apparatus consists of a single-chambered airbag as disclosed in FIG. 1. However, further embodiments of the present invention include multi-chambered airbags which, by their design, increase the effectiveness of the airbag apparatus. Referring to FIG. 3, one such embodiment of the present invention comprises a multi-chambered airbag 10 having a first chamber 10a and a second chamber 10b that are of a generally circular configuration, with the first chamber 10a having a slightly larger diameter than the second chamber lob and being adapted to permit the airbag to be secured to the housing by the retaining means. Each chamber of the airbag 10 is independently connected to the propellant (not shown), for example the second chamber 10b may be connected to the propellant by way of a soft hose 11 running through the interior of the first chamber 10a. Each of the first chamber 10a and second chamber 10b is fitted with a valve, 12a and 12b, respectively, to permit the airbag 10 to be controllably deflated during the vehicle impact by using a valve 12a on the first chamber 10a that will open at a different air bag internal pressure than the valve 12b on the second chamber 10b. Having valves 12a and 12b open at different air bag internal pressures allows differential deflation of the first chamber 10a and second chamber 10b which has the advantage of allowing the impact of the collision to be absorbed by the air bag apparatus in stages.

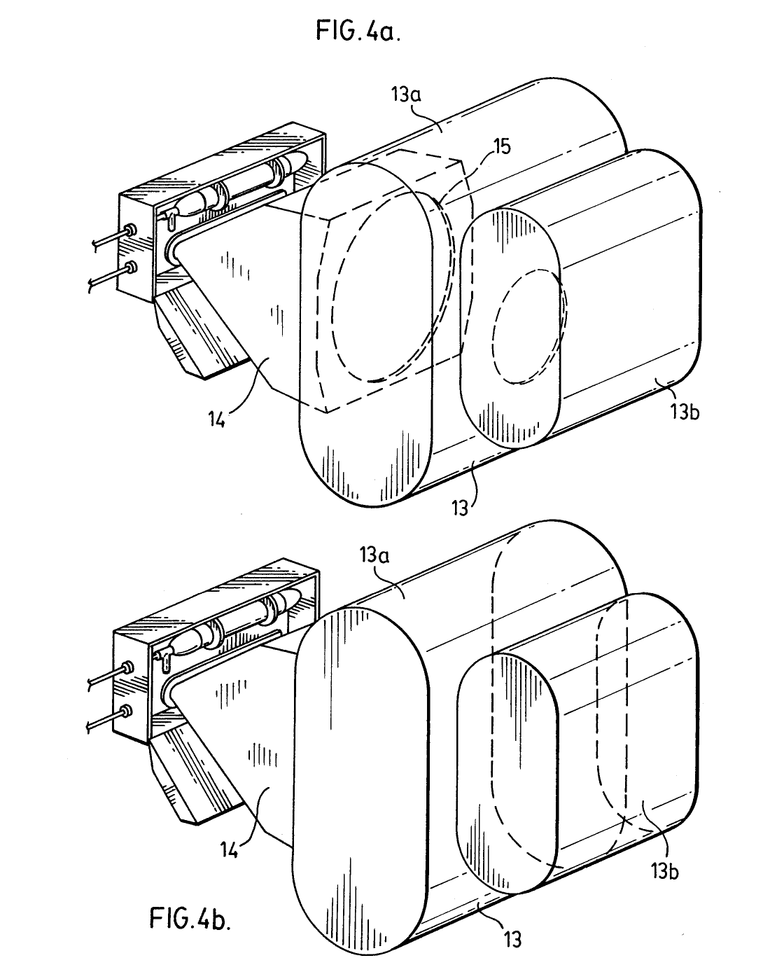

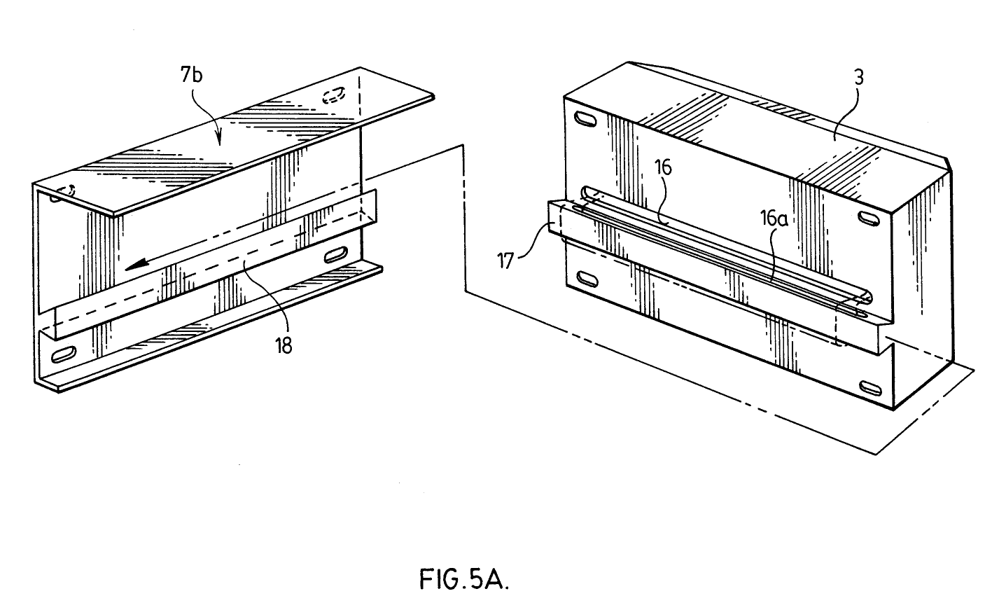

Referring to FIG. 4a and 4b, a further multi-chambered airbag 13 comprises a first chamber 13a and a second chamber 13b whereby the first chamber is adapted to permit the airbag to be secured to the housing by the retaining means (not shown) and whereby the first chamber 13a and second chamber 13b are generally of the same shape but where the dimensions of the first chamber 13a are larger than the second chamber 13b and the first chamber 13a and second chamber 13b communicate by way of an orifice 15 at the interface between the two chambers.

Thus, when a driver of a first vehicle that has the air bag apparatus of the present invention installed becomes aware of an impending low speed collision, he or she activates the air bag apparatus by engaging the trigger which activates the solid propellant or compressed gas inflation system and effects the inflation of the external air bag. Upon collision with a second vehicle, the second vehicle first comes in contact with the deployed air bag and compresses the air bag such that the air bag internal air pressure increases until it reaches a predetermined level at which point the release valve opens permitting the air bag to begin deflating. The valve remains opens so long as air bag internal air pressure remains at the predetermined level. Such controlled deflation effectively absorbs some of the force that would otherwise transferred to the first vehicle upon collision with the second vehicle.

Various embodiments of the present invention having been thus described in details by way of example, it will be apparent to those skilled in the art that variations and modifications may be made without departing from the invention. The invention includes all such variations and modifications as fall within the scope of the appended claims.

I claim:

1. An airbag apparatus for mounting on an external surface of a vehicle and for deployment in advance of a low speed collision, comprising
a housing,
an airbag mounted in the housing,
a propellant for inflating the air bag, and
a trigger for releasing the propellant,
whereby the airbag and propellant are mounted within said housing and said housing is removably mounted to an external surface of a vehicle and whereby said propellant is triggered to inflate said airbag by said triggering means.

2. The airbag apparatus of claim 1 in which the propellant is contained within the housing.

3. The airbag apparatus of claim 1 in which the airbag comprises a plurality of chambers, at least one chamber being adapted to secure the airbag within the housing by a retaining means and at least one chamber being adapted to allow the airbag to be inflated by the propellant.

4. The airbag apparatus of claim 3 in which the retaining means comprises an elongate slotted bracket whereby the slot is closed at the first end and open at the second end provided with a means for releasably closing the second end.

5. The airbag apparatus of claim 4 in which the means for releasably closing the second end comprises a hinged clasp.

6. The airbag apparatus of claim 1 in which the trigger comprises at least one depressible switch located within the vehicle passenger compartment.

7. The airbag apparatus of claim 1 in which the housing is mounted on an adaptor comprising a wedge divided into a first portion and a second portion, the first portion having a first surface and the second portion having a second surface, whereby the ramp is mounted to the vehicle at the first surface and the airbag apparatus is mounted to the ramp at the second surface

8. The airbag apparatus of claim 7 in which the first portion and second portion are joined at a narrow end of the ramp by a flexible joint and a spacing between the first and second portions at a wider end is adjustable to thereby control the angle of the ramp and the direction at which the airbag is deployed.

9. The airbag apparatus of claim 7 in which said adapter means is an integral component of the housing.

10. The airbag apparatus of claim 1 in which said external vehicle surface is a front or rear vehicle bumper.

11. The airbag apparatus from claims 10 in which the external vehicle surface comprises the vehicle's means for affixing a license plate.

12. An airbag for an airbag apparatus, comprising a plurality of chambers, each chamber comprising a means for permitting inflation by a propellant and a valve for permitting controlled deflation at a predetermined air bag chamber internal air pressure.
